(19) United States
(12) Patent Application Publication
(10) Pub. No.: US 2008/0072932 A1
(43) Pub. Date: Mar. 27, 2008

(54) Paint roller cover washer

(76) Inventor: Geoffry Nicholas, (US)

Correspondence Address: GREGORY SMITH & ASSOCIATES, 3900 NEWPARK MALL ROAD, 3RD FLOOR, NEWARK, CA, 94560, US

(21) Appl. No.: 11/529,664

(22) Filed: Sep. 27, 2006

(51) Int. Cl. B08B 3/00

(52) U.S. Cl. 134/34; 134/198

(57) ABSTRACT

A paint roller cover washer comprises a chamber open at one end to allow a used paint roller cover to be slipped in onto a spindle. A capped pipe section is attached along one side of the chamber parallel to the spindle, and the pipe section can be connected to a common garden water hose. Several jet nozzles along the pipe section are all directed into the chamber and water jet sprays from them will spin the roller cover on the spindle. The spinning allows the water to contact all areas of the roller cover to dilute the paint enough so it will flow off and out of the chamber. The spinning also helps the paint to be flung off with centrifugal force. A relatively small amount of water can be used to clean the roller cover of paint.

### FIELD OF THE PRESENT INVENTION

The present invention relates to paint cleanup methods and tools, and in particular to a tool attached to a water hose for washing paint from a paint roller cover.

### BACKGROUND

Latex house paints are very easy to use, and cleanup can be done with water before the paint dries. Before such latex paints, oil-based paints had to be cleaned up with dangerous chemicals like mineral spirits, paint thinners, kerosene, and other solvents.

Paint roller covers allow large areas like walls, ceilings, and floors to be painted quickly and efficiently. Many paint roller covers comprises removable, disposable tubes that can be slipped onto roller cover handles. Some roller covers are more expensive than others and perform better. So the usual practice is to clean these up with water and use them again.

At least one company, ATCI Consumer Products (Troy, MI), figures not cleaning the roller cover at all is the best way to allow re-use later. They market a ROLLER COVER-SAVER that puts the wet roller cover in a clamshell plastic package and keeps it wet. Of course, the same paint must be used again in the later application within several hours. Other companies make “spinner” poles that rotate a roller cover sleeve at high speed so excess paint can be flung off inside a bucket before cleaning with soap and water. Some spin the roller cover to spin it dry of water once cleaned.

Even inexpensive roller covers can be re-used if cleaned up well enough. It takes a lot of water and agitation to remove enough paint residue to allow re-use after drying. Simply soaking the used paint roller cover in a bucket or pan of water will not do the job. Scrubbing the soaking roller cover is messy and a lot of trouble.

Prior art devices that direct sprays of water onto paint roller covers to wash them clean are generally complex and expensive to manufacture. Several have elaborate chambers and spindles, and finely machined and positioned jets to spin and dry the roller covers. Such have lost sight of the fact that many do-it-yourselfers are only using their inexpensive roller covers a few times a month, and such hardly warrants the purchase of relatively expensive cleaning and washing devices. It is often now cheaper to just dispose of a used roller cover and buy a new one when needed later.

So what is needed is a simple way to clean a paint roller cover that will be affordable and get the job done with a minimum of trouble and mess. The most direct way to accomplish this is to use common materials and the fewest number of parts and machining steps in the manufacture.

### SUMMARY OF THE PRESENT INVENTION

A paint roller cover washer embodiment of the present invention comprises a chamber open at one end to allow a used paint roller cover to be slipped in onto a spindle. A pipe section is attached along one side of the chamber parallel to the spindle, and the pipe section can be connected to a common garden water hose. Several jet nozzles along the pipe section are all directed into the chamber and water jet sprays from them will spin the roller cover on the spindle. The spinning allows the water to contact all areas of the roller cover to dilute the paint enough so it will flow off and out of the chamber. The spinning also helps the paint to be flung off with centrifugal force. A great deal of water can be used to completely flood and clean the roller cover of paint.

An advantage of the present invention is a paint roller cover washer is provided that is simple to use.

Another advantage of the present invention is a paint roller cover washer is provided that is inexpensive to manufacture.

The above summary of the present invention is not intended to represent each disclosed embodiment, or every aspect, of the present invention. Other aspects and example embodiments are provided in the figures and the detailed description that follow.

### BRIEF DESCRIPTION OF THE DRAWINGS

The present invention maybe more completely understood in consideration of the following detailed description of various embodiments of the present invention in connection with the accompanying drawings, in which:

FIGS. 1A and 1B are a perspective view diagrams of a first paint-roller cover washer embodiment of the present invention in which a spindle or handle frame in a cap holds a wet paint roller cover inside a chamber for washing;

FIGS. 2A and 2B are a perspective view diagrams of a second paint-roller cover washer embodiment of the present invention in which the wash chamber is closed at upper end where the roller cover spindled. The manifold tube is extended for a support foot;

FIGS. 3A and 3B are a perspective view diagrams of a third paint-roller cover washer embodiment of the present invention in which the wash chamber is closed at one end and the roller cover on a handle frame is dangled in the open end of the chamber, the manifold tube is also extended into a foot for support on the ground while in use;

FIGS. 4A-4C are perspective view diagrams of the third paint-roller cover washer embodiment of the present invention in which the dangled roller cover and handle frame are wiggled about in the open end of the chamber for maximum washing effect;

FIG. 5 is a side view diagram of the third paint-roller cover washer embodiment of the present invention in which the support foot is placed in a pan to collect wash water; and

FIG. 6 is cross-sectional view diagram of a paint-roller cover washer embodiment of the present invention showing how two simple PVC pipe sections can be drilled, grooved, and cemented together to form the major components needed as in FIGS. 1A, 1B, 2A, 2B, 3A, 3B, 4A-4C, and 5.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention as defined by the appended claims.

### DETAILED DESCRIPTION

A paint roller cover washer built in accord with the present invention comprises a chamber open at one end to allow a used paint roller cover to be slipped in onto a spindle. A pipe section is attached along one side of the chamber parallel to the spindle, and the pipe section can be connected to a common garden water hose. Several jet nozzles along the pipe section are all directed into the chamber and water jet sprays from them will spin the roller cover on the spindle. The spinning allows the water to contact all areas of the roller cover to dilute the paint enough so it will flow off and out of the chamber. The spinning also helps the paint to be flung off with centrifugal force. A great deal of water can be used to completely flood and clean the roller cover of paint.

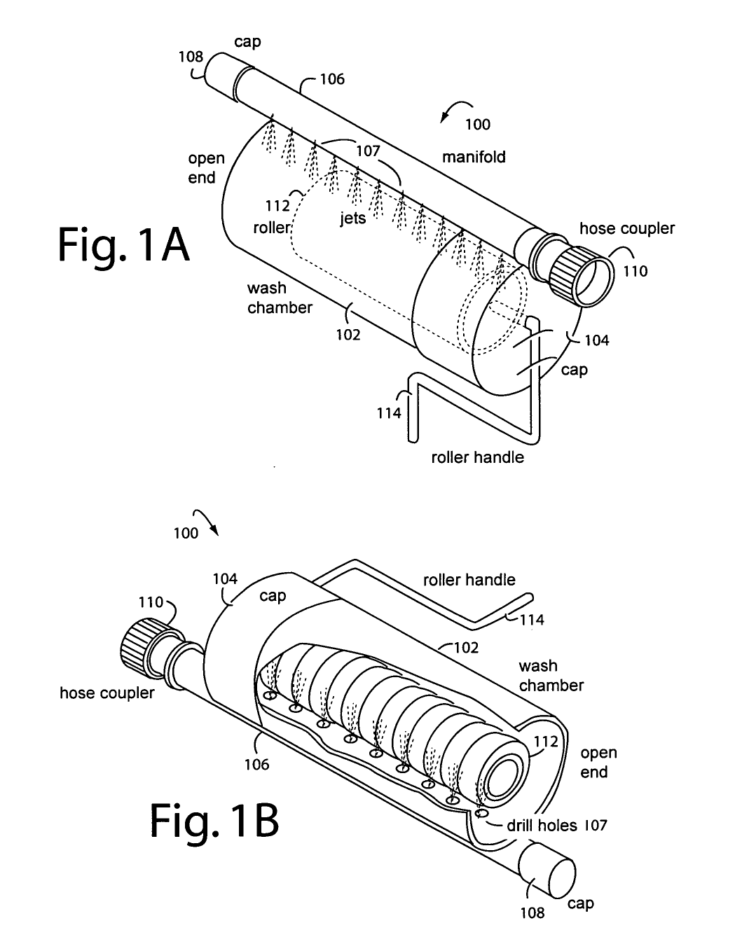

FIGS. 1A and 1B represent a paint-roller cover washer embodiment of the present invention, and is referred to herein by the general reference numeral 100. The washer 100 comprises a wash chamber 102 with an end cap 104 attached lengthwise to a manifold 106. A series of drill holes 107 provides for a row of water spray jets. A cap 108 is placed on the manifold pipe section opposite to a water hose coupler 110. A wet, used paint roller cover 112 is slipped into the chamber 102 onto either a spindle or handle frame 114 attached to end cap 104. In some embodiments, it maybe desirable for cap 104 to be removable to facilitate the insertion and removal of roller cover 112. The water spray jets flood the roller cover 112 with water in order to dilute water-based paints and adhesives enough so the roller cover may be dried and re-used later.

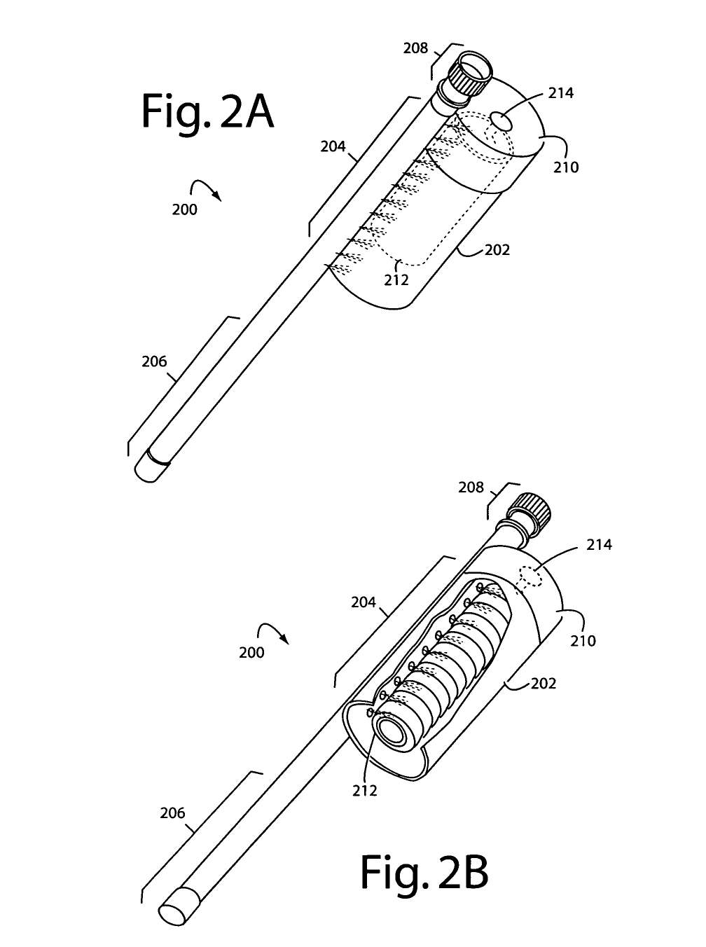

FIGS. 2A and 2B represent a paint roller cover washer in a second embodiment of the present invention, and is referred to herein by the general reference numeral 200. The washer 200 comprises a wash chamber 202 attached lengthwise to a manifold section 204 of a 2-3 foot long pipe. A series of drill holes provides for a row of water spray jets into chamber 202. A foot extension 206 will fill with water during use and become heavy. If the distal end is laid on the ground, such foot extension will stabilize the washer 200 and make it easier to use. A garden hose is attached to a hose coupler 208. A cap 210 closes one, upper end of chamber 202. A wet, used paint roller cover 212 on a roller cover frame or spindle 214 is slipped into the chamber 202 for washing. As in washer 100, the water spray jets will flood the roller cover 212 with water provide by the hose. Enough water, and maybe soap, are used to dilute water-based paints and adhesives enough so the roller cover 212 may be dried and re-used later.

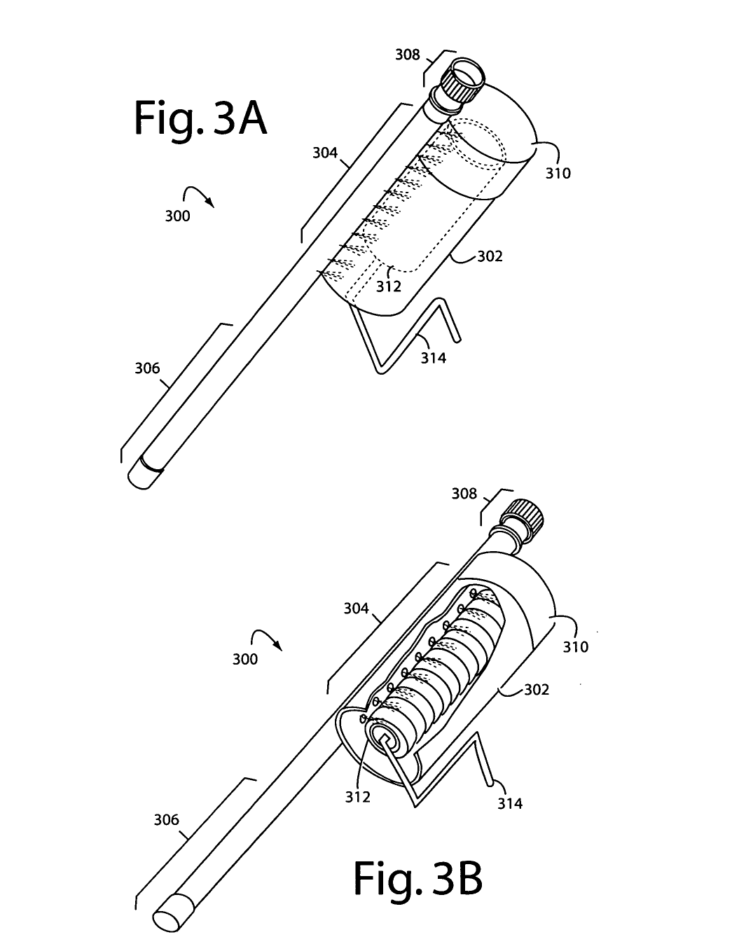

FIGS. 3A and 3B represent a paint roller cover washer in a second embodiment of the present invention, and is referred to herein by the general reference numeral 300. The washer 300 comprises a wash chamber 302 attached lengthwise to a manifold section 304 of a 2-3 foot long pipe. A series of drill holes provides for a row of water spray jets into chamber 302. A foot extension 306 will fill with water during use and become heavy. If the distal end is laid on the ground, such foot extension will stabilize the washer 300 and make it easier to use. A garden hose is attached to a hose coupler 308. A cap 310 closes one, upper end of chamber 302. A wet, used paint roller cover 312 on a frame handle 314 is slipped into the chamber 302 for washing. As in washer 100, the water spray jets will flood the roller cover 312 with water provide by the hose. Enough water, and maybe soap, are used to dilute water-based paints and adhesives enough so the roller cover 312 may be dried and re-used later. In this embodiment, the chamber is very simple and provides no spindle or mechanism to hold the roller cover 312 or handle frame 314. The user dangles the roller cover inside the chamber while the water is flowing to get the maximum washing effect, e.g., as seen by the color of the wash water flowing out.

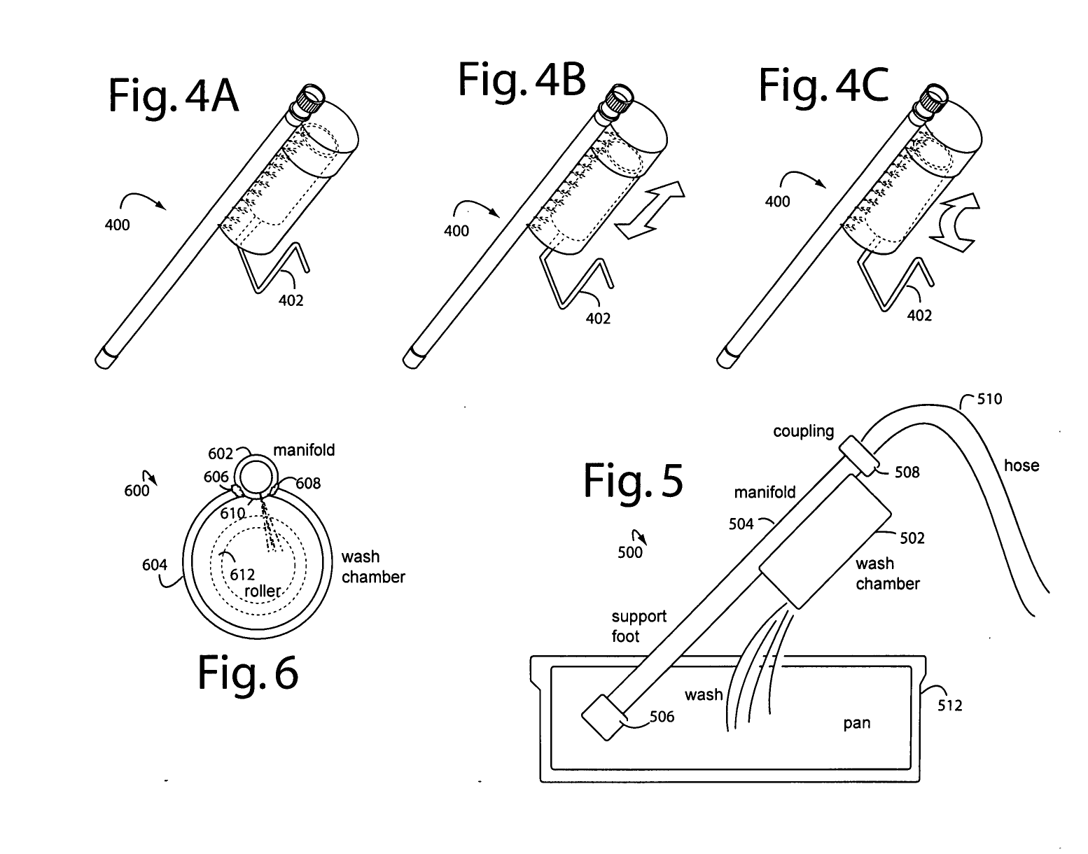

Such dangling and wiggling of the roller cover inside the chamber is illustrated in FIGS. 4A-4C. A washer 400 has a roller cover and handle 402 inserted in its wash chamber. A spinning action on the roller cover can be imparted by the water jets if the relative position of the roller cover is just right. Whatever juggling about produces the clearest water flow in the shortest time will probably be the most efficient. For example, about a minute or two.

FIG. 5 represents a washer and pan assembly 500. A wash chamber 502 has a manifold 504 like those illustrated in FIGS. 1A, 1B, 2A, 2B, 3A, 3B, and 4A-4C. A support foot 506 has a rubber, non-slip cane-type cap, and gets heavy with fill water during use to stabilize the whole. A standard coupler 508 connects to a hose 510. A shallow pan or 5-gallon bucket 512 collects wash water so such can be disposed of properly later. The usual job will use about 1-1.5 gallons of water per roller cover.

FIG. 6 represent the simple way a washer 600 can be constructed. Basically, a wash chamber 604 is made, for example, from a ten-inch section of 2″ diameter white PVC pipe. Clear plastic material may be used in alternative embodiments to allow a user to see how the roller cover washing is progressing. The wash chamber 604 is grooved or machined with a router to partially inlay a 24-inch length of ¾″ diameter white PVC pipe. The two pipes are joined with beads of PVC cement/solvent 606 and 608, for example, that actually dissolve and weld the plastics together. Care is taken during gluing not to block the water spray jets, e.g., by masking. A series of 1/16″ to ⅛″ diameter holes 610 are drilled in pipe 602 to provide a water jet manifold. The holes 610 are generally desired to run in a single line with a drill angle tangent to the pipe cross-section. A used, wet paint roller cover 612 can then be placed inside for washing.

While the present invention has been described with reference to several particular example embodiments, those skilled in the art will recognize that many changes may be made thereto without departing from the spirit and scope of the present invention, which is set forth in the following claims.

1. A paint roller cover washer, comprising:
a chamber open at one end to allow a used paint roller cover to be slipped in onto a spindle;
a manifold pipe section attached along one side of the chamber parallel to the spindle, and the pipe section can be connected to a common garden water hose; and
a series of jet nozzles along the pipe section directed into the chamber so water jet sprays from them can spin the roller cover on the spindle, wherein, the spinning allows water to contact areas of the roller cover to dilute the paint enough so it will flow off and out of the chamber;
wherein, a spinning helps the paint to be flung off with centrifugal force, and water can be used to completely flood and clean the roller cover of paint.

2. The washer of claim 1, further comprising:
a support foot extension to the manifold pipe section that gets heavy with water during use and helps stabilize the washer when its end is rested on a support.

3. A paint-roller cover washer, comprising:
a cylindrical chamber comprising a first section of plastic pipe with an inside diameter large enough to fully accommodate a paint roller cover and providing for rotation of said paint roller cover;
a manifold comprising a second section of plastic pipe cemented and joined lengthwise to the cylindrical chamber, and providing for a source of wash water through a line of water spray jets into the cylindrical chamber; and
a hose coupler disposed at one end of the manifold and providing for a connection to a water hose;
wherein is provided a means to wash said paint roller cover of a water-based material and enable drying and later re-use.

4. The washer of claim 3, further comprising:
a support extension to the manifold long enough to act as a foot to lay on the ground and help stabilize the washer for a user.

5. A method for washing of a paint roller cover, comprising:
arranging a row of water spray jets to enter a cylindrical washing chamber on the side along the length;
introducing a paint roller cover on a handle frame into said washing chamber while a flow of water is present; and
holding by hand the handle frame such that the washing of said paint roller cover is maximized by the visual appearance of waste wash seen by said user.

6. The method of claim 5, further comprising:
stabilizing said cylindrical washing chamber for said user with an extension foot for ground support.

7. The method of claim 6, further comprising:
further stabilizing said cylindrical washing chamber for said user by an automatic filling of said extension foot with water diverted from said row of water spray jets.
